(19) United States
(12) Patent Application Publication
(10) Pub. No.: US 2008/0014494 A1
(43) Pub. Date: Jan. 17, 2008

(54) Catalysts Including Metal Oxide For Organic Fuel Cells

(76) Inventors: Coca Iordache, Vancouver (CA); Sharon Blair, Coquitlam (CA); Derek Lycke, Vancouver (CA); Sean Huff, Coqultlam (CA)

Correspondence Address: MCANDREWS HELD & MALLOY, LTD, 500 WEST MADISON STREET, SUITE 3400, CHICAGO, IL, 60661, US

(21) Appl. No.: 11/776,375

(22) Filed: Jul. 11, 2007

Related U.S. Application Data
(60) Provisional application No. 60/830,064, filed on Jul. 11, 2006.

(51) Int. Cl. H01M 4/90; H01M 4/92; H01M 4/88; B05D 5/12; B01J 23/42

(52) U.S. Cl. 429/40; 502/101; 427/115; 502/339

(57) ABSTRACT

A catalyst formulation for an organic fuel cell, for example a formic acid fuel cell, includes a metal oxide and a noble metal. The catalyst formulation can include a noble metal supported on a metal oxide. The metal oxide can store and release catalyst poisons at room temperature and therefore reduces the exhaustion of the fuel cell.

### CROSS-REFERENCE TO RELATED APPLICATION(S)

This application is related to and claims priority benefits from U.S. Provisional Patent Application Ser. No. 60/830,064 filed Jul. 11, 2006, entitled “Catalysts Including Metal Oxide For Organic Fuel Cells”. The '064 provisional application is hereby incorporated by reference herein in its entirety.

### FIELD OF THE INVENTION

The present invention relates generally to catalysts for organic fuel cells that include metal oxides. More particularly, the invention relates to noble metal catalysts supported on metal oxides for organic fuel cells

### BACKGROUND OF THE INVENTION

Fuel cells are electrochemical cells in which a free energy change resulting from a fuel oxidation reaction is converted into electrical energy. Organic fuel cells are a useful alternative in many applications to hydrogen fuel cells, overcoming the difficulties of storing and handling hydrogen gas. In an organic fuel cell, an organic fuel such as methanol is oxidized to carbon dioxide at an anode, while air or oxygen is simultaneously reduced to water at a cathode. Organic/air fuel cells have the advantage of operating with a liquid organic fuel. Although methanol and other alcohols are typical fuels of choice for direct fuel cells, formic acid fuel cells with high power densities and current output have been described in U.S. Patent Application Publication Nos. 2003/0198852 and 2004/0115518. Exemplary formic acid fuel cell power densities of 15 mW/cm² and much higher were achieved at low operating temperatures, and provided for compact fuel cells.

Fuel cells are electrochemical cells in which a free energy change resulting from a fuel oxidation reaction is converted into electrical energy. Applications for fuel cells include battery replacement; mini- and microelectronics such as portable electronic devices; sensors such as gas detectors, seismic sensors, and infrared sensors; electromechanical devices; automotive engines and other transportation power generators; power plants, and many others. One advantage of fuel cells is that they are substantially pollution-free.

Electrochemical fuel cells convert fuel and oxidant fluid streams to electricity and reaction product. Solid polymer electrochemical fuel cells generally employ a membrane electrode assembly (MEA) comprising a solid polymer electrolyte or ion-exchange membrane disposed between two porous electrically conductive electrode layers. An electrocatalyst is typically disposed at each membrane/electrode layer interface to induce the desired electrochemical reaction.

The electrode substrate typically comprises a sheet of porous, electrically conductive material, such as carbon fiber paper or carbon cloth. The layer of electrocatalyst is typically in the form of finely comminuted metal, such as platinum, palladium, or ruthenium, and is disposed on the surface of the electrode substrate at the interface with the membrane electrolyte in order to induce the desired electrochemical reaction. In a single cell, the electrodes are electrically coupled to provide a path for conducting electrons between the electrodes through an external load.

The fuel stream directed to the anode by a fuel flow field migrates through the porous anode and is oxidized at the anode electrocatalyst layer. The oxidant stream directed to the cathode by an oxidant flow field migrates through the porous cathode and is reduced at the cathode electrocatalyst layer.

Electrochemical fuel cells can employ gaseous fuels and oxidants, for example, those operating with molecular hydrogen as the fuel and oxygen in air or a carrier gas (or substantially pure oxygen) as the oxidant. In hydrogen fuel cells, hydrogen gas is oxidized to form water, with a useful electrical current produced as a byproduct of the oxidation reaction. A solid polymer membrane electrolyte layer can be employed to separate the hydrogen fuel from the oxygen. The anode and cathode are arranged on opposite faces of the membrane. Electron flow along the electrical connection between the anode and the cathode provides electrical power to load(s) interposed in circuit with the electrical connection between the anode and the cathode. The anode and cathode reactions in hydrogen/oxygen fuel cells are shown in the following equations:
Anode reaction: H₂→2H⁺+2e⁻
Cathode reaction: ½O₂+2H⁺+2e⁻→H₂O

The catalyzed reaction at the anode produces hydrogen cations (protons) from the fuel supply. The ion-exchange membrane facilitates the migration of protons from the anode to the cathode. In addition to conducting protons, the membrane isolates the hydrogen-containing gaseous fuel stream from the oxygen-containing gaseous oxidant stream. At the cathode electrocatalyst layer, oxygen reacts with the protons that have crossed the membrane to form water as the reaction product. Hydrogen fuel cells are impractical for many applications, however, because of difficulties related to storing and handling hydrogen gas.

Organic fuel cells may prove useful in many applications as an alternative to hydrogen fuel cells. In an organic fuel cell, an organic fuel such as methanol or formic acid is oxidized to carbon dioxide at an anode, while air or oxygen is simultaneously reduced to water at a cathode. One advantage over hydrogen fuel cells is that organic/air fuel cells can be operated with a liquid organic fuel. This diminishes or eliminates problems associated with hydrogen gas handling and storage. Some organic fuel cells require initial conversion of the organic fuel to hydrogen gas by a reformer. These are referred to as “indirect” fuel cells. A reformer increases cell size, cost, complexity, and start up time. Other types of organic fuel cells, called “direct,” operate without a reformer by directly oxidizing the organic fuel without conversion to hydrogen gas. To date, fuels employed in direct organic fuel cell development include methanol and other alcohols, as well as formic acid and other simple acids.

In direct liquid feed fuel cells, the reaction at the anode produces protons, as in the hydrogen/oxygen fuel cell described above. The protons (along with carbon dioxide) result from the oxidation of the organic fuel, such as formic acid. An electrocatalyst promotes the organic fuel oxidation at the anode. The organic fuel can alternatively be supplied to the anode as vapor, but it is generally advantageous to supply the organic fuel to the anode as a liquid, preferably as an aqueous solution. The anode and cathode reactions in a direct formic acid fuel cell are shown in the following equations:
Anode reaction: HCOOH→2H⁺+CO₂+2e⁻
Cathode reaction: O₂+2H⁺+2e⁻→2H₂O
Overall reaction: HCOOH+O₂→CO₂+2H₂O

The protons formed at the anode electrocatalyst migrate through the ion-exchange membrane from the anode to the cathode, and at the cathode electrocatalyst layer, the oxidant reacts with the protons to form water.

One obstacle to the widespread commercialization of direct fuel cell technology is the exhaustion of fuel cells. Fuel cells can become exhausted due to the accumulation of poisonous species, particularly carbon monoxide (CO), on the anode. Fuel cells can also become exhausted due to the formation of oxides at the cathode. For example, if a platinum catalyst is employed on the cathode, some of the platinum can be oxidized to form platinum oxides. The oxidation of the cathode catalyst decreases the activity of the catalyst and therefore decreases the effectiveness of the fuel cell as a power source. Additionally, a fuel cell can become exhausted due to membrane dry-out.

In WO 2005/048379, unsupported palladium is used as a catalyst for formic acid electro-oxidation. U.S. Patent Application Publication No. 2003/0198852 discloses an anode catalyst containing nanoparticles of noble metals, or Ru, Co, Fe, Ni, and/or Mn having a coating of platinum, palladium, or ruthenium on their surface.

Various parties have investigated the stability of noble metal catalysts in the electro-oxidation of formic acid. For example, A. Capon and R. Parsons investigated palladium (Pd), platinum (Pt), rhuthenium (Rh), iridium (Ir) and gold (Au) in the electro-oxidation of formic acid and concluded that platinum catalysts are more stable than palladium catalysts, but palladium catalysts are more active than platinum catalysts. See J. Electroanal. Chem., 44 (1973) 239; J. Electroanal. Chem., 45 (1973) 205. Wieckowsky et al. examined the reaction mechanism on pure platinum, pure palladium, and platinum-palladium catalysts and reached the same conclusion as Capon and Parsons. J. Physical Chem. B. 103, 9700 (1999). The Adzic group investigated the effect of foreign metal monolayers such as Pb, Cd, Bi, Ti, Ag, and Cu, on platinum and palladium catalysts in the electro-oxidation of formic acid. J. Electroanal. Chem., 92 (1978) 31-43; J. Electroanal. Chem., 150 (1983) 79-88. DiSalvo and Abruna have investigated the effect of an ordered catalytic structure obtained from platinum decorated with Bi or Pb on formic acid oxidation. Chemphyschem. 2003, 4, 193-199.

Energy-consuming regeneration procedures can be used to recover the fuel cell performance. This regeneration, however, requires an input of power to the fuel cell and can also damage fuel cell components. In addition, even with an optimized regeneration protocol, a significant voltage drop (greater than 100 mV) can occur in the first 300 hours of cell operation.

In direct liquid feed fuel cells, removal of the catalyst poison can be accomplished by reducing the catalyst poison to methane or by oxidizing the catalyst poison to carbon dioxide. Oxidizing the catalyst poison is advantageous because it does not consume hydrogen.

There is thus a need for a catalyst formulation that is well-suited to liquid fuels such as formic acid and that reduces the poisoning of the catalyst and the need for regeneration while maintaining the overall performance of the fuel cell.

### SUMMARY OF THE INVENTION

One or more shortcomings of conventional catalyst formulations for a liquid feed fuel cell are overcome by the present catalyst formulations. In one embodiment, a catalyst comprises a noble metal and a metal oxide. In a preferred embodiment, the noble metal is supported on the metal oxide. Suitable noble metals include palladium and platinum, while suitable metal oxides include TiO₂, CeO₂, ZrO₂, alloys thereof, or combinations thereof.

In another embodiment, a direct organic liquid feed fuel cell comprises
(a) an anode;
(b) a cathode;
(c) a liquid organic fuel; and
(d) an anode catalyst, wherein the anode catalyst comprises a noble metal and a metal oxide.

In a preferred embodiment, the liquid organic fuel is formic acid.

In a further embodiment, a method of reducing catalyst poisoning in a direct organic liquid feed fuel cell comprises preparing a catalyst comprising a noble metal and a metal oxide.

In a further embodiment, a method of preparing an anode catalyst for a direct liquid feel fuel cell comprises admixing a noble metal and a metal oxide and depositing the admixture on an electrically conductive sheet material to form an anode.

### BRIEF DESCRIPTION OF THE DRAWINGS

FIG. 1 is a cyclic voltammogram of various Pd catalyst formulations in 0.1M formic acid and 0.1M H₂SO₄ with a sweep rate of 5 mV/s.

FIG. 2 is a cyclic voltammogram of various Pt catalyst formulations in 0.1M formic acid and 0.1M H₂SO₄ with a sweep rate of 5 mV/s.

FIG. 3 is a cyclic voltammogram of various Pd—Pt catalyst formulations in 0.1M formic acid and 0.1M H₂SO₄ with a sweep rate of 5 mV/s.

FIG. 4 is a molecular representation showing titanium, oxygen and palladium where the palladium is supported on TiO₂.

FIG. 5 is a molecular representation of the structure of CeO₂.

FIGS. 6A, 6B and 6C depict oxygen vacancies where Ce is in the Ce³⁺ state, Ce⁴⁺ state, and a variety of states, respectively.

FIG. 7A is a molecular representation of CeO₂ nanoparticles.

FIG. 7B depicts the {111} and {100} crystal lattice surfaces of CeO₂.

### DETAILED DESCRIPTION OF PREFERRED EMBODIMENT(S)

A catalyst formulation is provided as a catalyst for organic liquid feed fuel cells where the catalyst formulation reduces catalyst poisoning and exhaustion of the fuel cell while maintaining catalyst life and reactivity. These catalysts are also suitable for use in an acidic environment, such as with fuels like formic acid.

Fuel cells generally have an anode and a cathode disposed on either side of an electrolyte. The anode and cathode generally comprise an electrocatalyst, such as platinum, palladium, platinum-ruthenium alloys, or other noble metals or metal alloys. The electrolyte usually comprises a proton exchange membrane (PEM), typically a perfluorosulfonic acid polymer membrane, of which Nafion® is a commercial brand. At the anode, fuel is oxidized at the electrocatalyst to produce protons and electrons. The protons migrate through the proton exchange membrane to the cathode. At the cathode, the oxidant reacts with the protons. The electrons travel from the anode to the cathode through an external circuit, producing an electrical current.

Liquid feed electrochemical fuel cells can operate using various liquid reactants. For example, the fuel stream can be methanol in a direct methanol fuel cell, or formic acid fuel in a DFAFC. The oxidant can be substantially pure oxygen or a dilute stream such as air containing oxygen.

The embodiments will be described in detail with respect to direct formic acid fuel cells (DFAFC), with applicability to other liquid fuel cells such as methanol.

As described above, the present technology relates to a catalyst for a direct liquid feed fuel cell where the catalyst includes a noble metal and a metal oxide. The present technology refers to a bifunctional type of catalytic mechanism in which the noble metal catalyst provides the active site for electro-oxidation of the small organic molecule and the metal oxide supplies sites for oxidation of poison intermediates.

In general, the noble metal provides an active site for electro-oxidation of the small organic molecules (fuel), and the metal oxide supplies sites for the oxidation of poison intermediates. The metal oxides have defects in their crystallite structures known as oxygen vacancies. These oxygen vacancies store and release a reactive oxygen form. The activated oxygen oxidizes the poison intermediate (usually carbon monoxide, or CO) to carbon dioxide, thereby cleaning the electrode surface and recovering catalyst performance.

The metal oxide can also serve as an active oxidic support for the noble metal. The noble metal supported on the metal oxide can be prepared utilizing an impregnation method. The surface area of the metal oxide can range between about 20 m²/g and about 100 m²/g.

In conventional fuel cells, the support is inert in electro-oxidation and increases the dispersion of the active catalytic material and prevents agglomeration. In the present technology, the oxidic supports have an active role in the reaction by oxidizing the poison species. Catalyst supports for fuel cells are typically carbonaceous materials that are conductive and inert. Metal oxide supports are semiconductive to insulating, but they are oxygen storage structures with the ability to release active oxygen species that can oxidize poison intermediates to carbon dioxide at room temperature. This behavior can reduce the power and fuel consuming regenerative steps currently required in the formic acid fuel cell operating conditions while maintaining the level of cell activity.

Suitable noble metals that can be employed as catalysts include platinum, palladium, platinum-palladium alloys, platinum-ruthenium alloys, or other noble metals or metal alloys. Nanoparticles or other structures of these noble metals are also suitable catalysts.

Suitable metal oxides that can be employed with the noble metal catalysts include TiO₂, CeO₂, and ZrO₂, SnO₂, In₂O₅, Sb₂O₅, and combinations or alloys thereof.

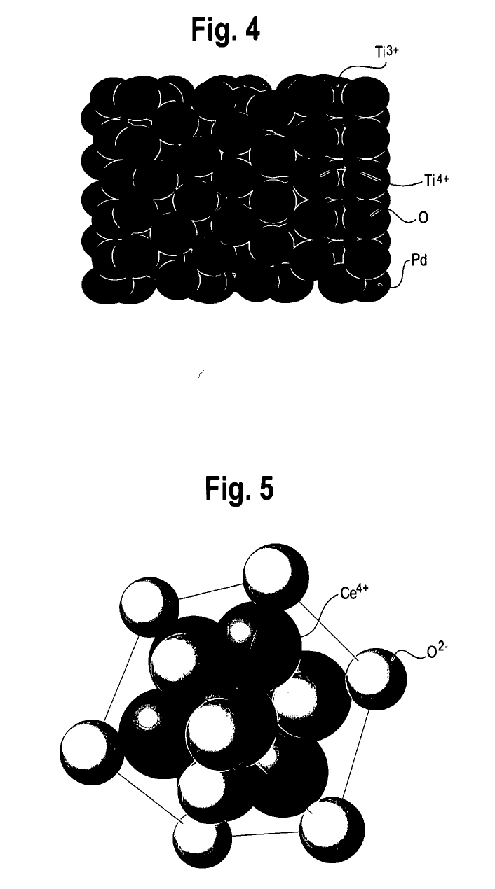

Titanium oxide (TiO₂), also known as titania, is a metal oxide that can be employed with a noble metal catalyst to reduce catalyst poisoning, including as a support. When noble metals are employed with titania, a metal-support interaction (SSMI) occurs which reduces the ability of the noble metal catalyst to absorb CO. FIG. 4 depicts a molecular representation of titanium atoms, oxygen atoms, and palladium atoms where titanium oxide is used as a support for a palladium catalyst.

Cerium oxide (CeO₂), also known as ceria, is also a metal oxide that can be employed with a noble metal catalyst to reduce catalyst poisoning, including as a support. The oxygen storage capacity and the catalytic activity for CO oxidation to carbon dioxide are connected to the relative ease with which cerium ions cycle between trivalent and tetravalent states. The cubic ceria lattice, as shown in FIG. 5, has a fluorite structure, where each Ce⁴⁺ cation is surrounded by eight O²⁻ ions that form the corners of a cube, and each O²⁻ is surrounded by four cations in a tetrahedron.

The oxygen storage behavior of ceria is the result of the balance between structural and kinetic (the rate of shift between the reduced (Ce³⁺) state and the oxidized (Ce⁴⁺) state of cerium) factors. Ceria maintains the local oxygen pressure by the following reaction:
CeO₂→CeO₂^{-x}+(x/2)O₂ (0≦x≦0.5)

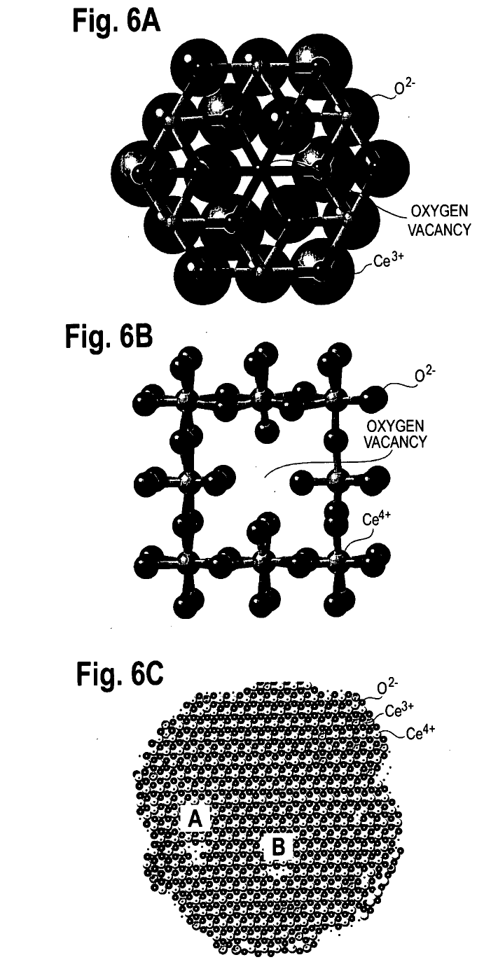

FIG. 6A depicts the oxygen vacancies present in the ceria structure where the cerium is in the reduced (Ce³⁺) state. FIG. 6B depicts the oxygen vacancies present in the ceria structure where the cerium is in the oxidized (Ce⁴⁺) state, and FIG. 6C depicts a variety of defect clusters where some of the cerium is in the reduced state and some of the cerium is in the oxidized state. The source for FIGS. 6A, 6B and 6C is T. X. T. Saye, S. C. Parker and D. C. Sayle, Phys. Chem. Chem. Phys., 2005, 7, pages 2936-2941.

Ceria functions as an oxygen buffer. Employing an oxygen storage material with the noble metal catalyst can lead to an increase in the local oxygen concentration. The oxygen released by the reduction of ceria facilitates the oxidation of carbon monoxide to carbon dioxide according to the following reaction where oxygen is extracted from an exposed surface rather than bulk:
CO_{(g)}+2CeO₂→CO₂+CeO₃

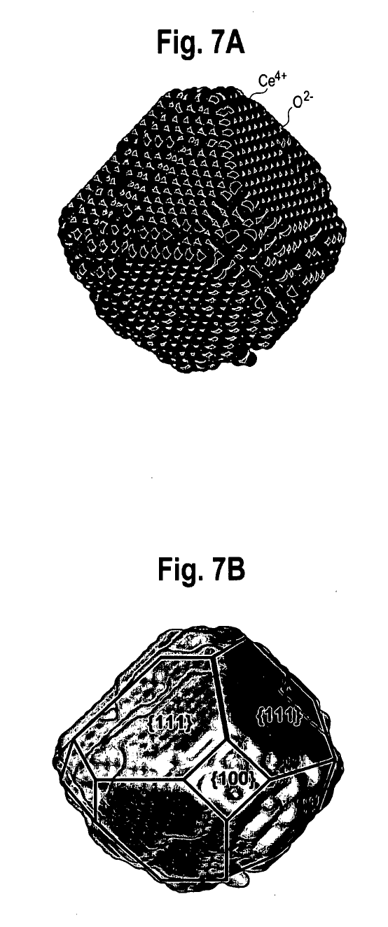

FIG. 7A depicts a molecular representation of ceria nanoparticles. FIG. 7B identifies the different kinds of nanoparticle surfaces of ceria. The source for FIGS. 7A and 7B is also T. X. T. Saye, S. C. Parker and D. C. Sayle, Phys. Chem. Chem. Phys., 2005, 7, pages 2936-2941.

Zirconium oxide (ZrO₂), also known as zirconia, is also a metal oxide that can be employed with a noble metal catalyst to reduce catalyst poisoning, including as a support.

Other metal oxides can also be employed with noble metal catalysts in the present technology. In addition, alloys or other combinations of the above metal oxides can be employed with noble metal catalysts in the present technology. For example, oxides and their mixtures of the metals from Groups IVB-VIIB of the Periodic Table and rare-earth metal oxides can be employed with noble metal catalysts. The role of the metal oxide support is to provide oxygen species to oxidize poison intermediates at low temperature where transition-metal oxides are more active than carbon-supported noble metals.

In the following examples, the noble metals and alloys supported on transition metal oxides were prepared using techniques described in D. V. Goia, J. Mater Chem, 14, 451-458 (2004), D. V. Goia, E. Matijevic, New J. Chem., 1203-1215 (1998), and U.S. Patent Publication 2006/0094597. These techniques involve the utilization of a polyol as both a solvent and a reducing agent in the presence of the metal oxide supports. Polyol solvents that can be used include 1,2-ethylene glycol (EG), diethylene glycol (DEG), 1,2-propylene glycol (PG), 1,3-propylene glycol, glycerol, as well as mixtures thereof. Optionally, polysaccharides and/or polymers may be added as stabilizers to produce protective colloids and to prevent particle agglomeration.

### EXAMPLE 1

### Pt/ZrO₂

0.29 g hexachloroplatinic acid hexahydrate (H₂PtCl₆.6H₂O, available from Alfa Aesar), 1.00 g zirconia (available from Sigma-Aldrich) and 0.4 g of protective colloid stabilizer (previously dissolved in 3 g of deionized water under mixing) are dissolved in 180 ml of 1,2-propylene glycol under a nitrogen blanket. The mixture is stirred for 2 hours and is subsequently brought to a refluxing temperature of 185° C. and maintained for 3 hours. The resulting suspension of metal clusters in 1,2-propylene glycol is cooled to room temperature and allowed to age for 1 hour. After 1 hour the pH of the solution is adjusted to 1 using dilute (1.5M) hydrochloric acid. The solution is heated to 60° C. and held at this temperature for 16 hours to hydrolyze the protective shell. The resultant Pt/ZrO₂ solid product is recovered by washing in water and acetone and drying in air.

### EXAMPLE 2

### Pd/CeO₂

0.24 g palladium nitrate Pd(NO₃)₂ (available from High Purity Standards), 1.00 g ceria (available from Sigma-Aldrich) and 0.4 g of protective colloid stabilizer (previously dissolved in 3 g of deionized water under mixing) are dissolved in 180 ml of 1,2-propylene glycol under a nitrogen blanket. The mixture is stirred for 2 hours and is subsequently brought to a refluxing temperature of 180° C. and maintained for 3 hours. The resulting suspension of metal clusters in 1,2-propylene glycol is cooled to room temperature. After 1 hour of aging, the pH of the solution is adjusted to 1 using dilute (1.5M) hydrochloric acid. The solution is heated to 60° C. and held at this temperature for 16 hours to hydrolyze the protective shell. The resultant Pt/CeO₂ solid product is recovered by washing in water and acetone and drying in air.

### EXAMPLE 3

### Pd/Pt (1:1 Atomic Ratio)/SbO₂—SnO₂

0.12 g palladium nitrate Pd(NO₃)₂ (available from High Purity Standards), 0.16 g hexachloroplatinic acid hexahydrate H₂PtCl₆.6H₂O (available from Alfa Aesar), 1.00 g SbO₂:SnO₂ (available from Alfa Aesar) and 0.4 g of protective colloid stabilizer (previously dissolved in 3 g of deionized water under mixing) are dissolved in 180 ml of 1,2-propylene glycol under a nitrogen blanket. The mixture is stirred for 2 hours and is subsequently brought to a refluxing temperature of 185° C. and maintained for 3 hours. The resulting suspension of metal clusters in 1,2-propylene glycol is cooled to room temperature and allowed to age for 1 hour. After 1 hour the pH of the solution is adjusted to 1 using dilute (1.5M) hydrochloric acid. The solution is heated to 60° C. and held at this temperature for 16 hours to hydrolyze the protective shell. The resultant Pd—Pt (1:1 atomic ratio)/SbO₂—SnO₂ solid product is recovered by washing in water and acetone and drying in air.

The electrochemical half cell procedure consisted of preparing and cleaning the electrode followed by cyclic voltammetry measurements to evaluate the formic acid electro-oxidation activity of the catalyst over a range of potentials. The electrodes were fabricated using a “direct paint” technique to apply a mixture of catalyst and recast Nafion® (5 wt %) on a gold substrate. The electrode was first cleaned with a dilute mixture of H₂SO₄ and H₂O₂. The electrode was then cleaned by potential cycling between oxidative and reductive potentials, with a sweep rate of 5 mV/s, until a steady-state voltammogram was attained.

Following electrochemical cleaning, a single cyclic voltammogram in 0.1M HCOOH and 0.1M H₂SO₄ was performed at a scan rate of 5 mV/s. All half cell measurements were conducted using a conventional three-electrode cell powered by a Keithley 2400 potentiostat. Pt served as the counter electrode and Ag/AgCl in 3M KCl as the reference electrode.

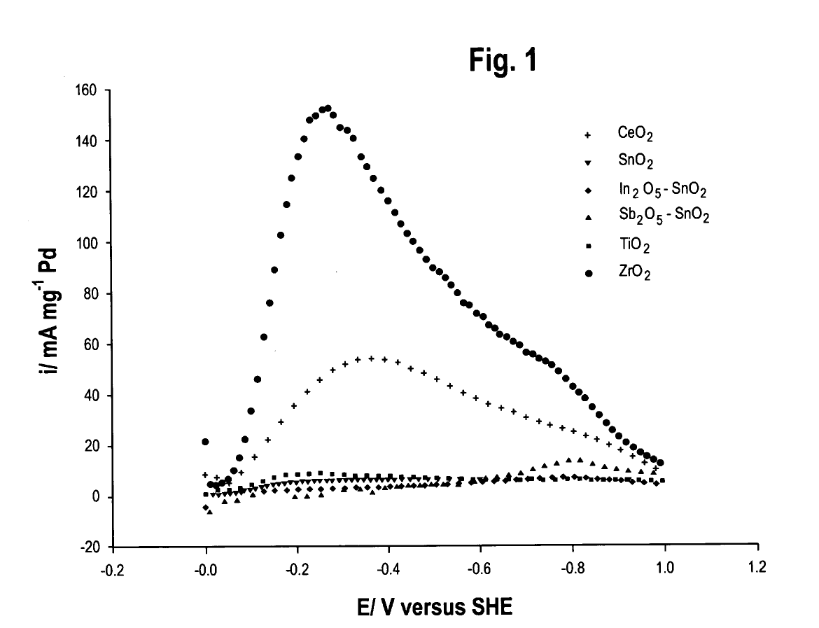

Cyclic voltammograms of Pt, Pd and Pd—Pt alloy supported on various metal oxides and their mixtures are illustrated in FIGS. 1-3. In order to compensate for the lower electrical conductivity of the catalyst, the powders were mixed with carbon in a weight ratio of 85% catalyst to 15% carbon black XC72R.

FIG. 1 shows a cyclic voltammogram of Pd supported on various metal oxides blended with carbon XC72R in a ratio of 85:15 by weight in 0.1M formic acid and 0.1M H₂SO₄ with a sweep rate of 5 mV/s.

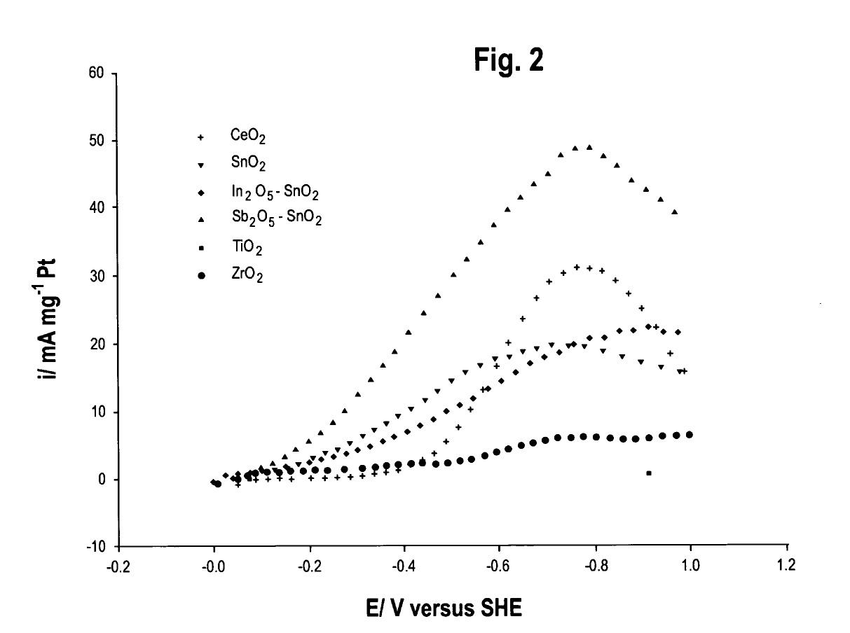

FIG. 2 shows a cyclic voltammogram of Pt supported on various metal oxides blended with carbon XC72R in a ratio of 85:15 by weight in 0.1M formic acid and 0.1M H₂SO₄ with a sweep rate of 5 mV/s.

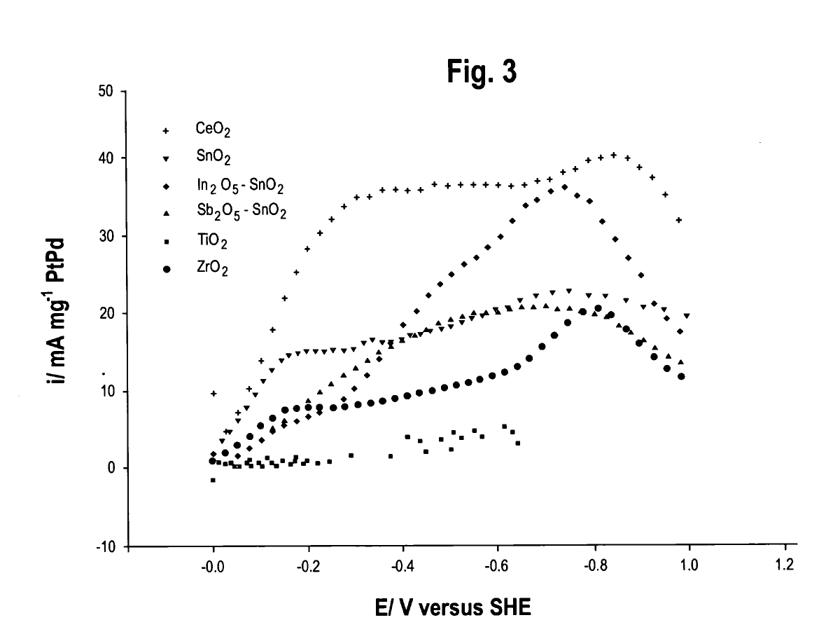

FIG. 3 shows a cyclic voltammogram of Pd—Pt alloy (1:1 atomic ratio) supported on various metal oxides blended with carbon XC72R in a ratio of 85:15 by weight in 0.1M formic acid and 0.1M H₂SO₄ with a sweep rate of 5 mV/s.

FIGS. 1-3 show that oxophilic metal oxides are active supports in the process of formic acid oxidation. Utilizing a noble metal or noble metal alloy catalyst with one or more metal oxides generally increases catalyst activity and decreases the potential at which formic acid oxidation and CO-type poisons oxidation occurs in comparison with noble metals or noble metal alloy catalysts without one or more metal oxides.

While particular elements, embodiments and applications of the present invention have been shown and described, it will be understood, of course, that the invention is not limited thereto since modifications can be made by those skilled in the art without departing from the scope of the present disclosure, particularly in light of the foregoing teachings.

What is claimed is:

1. A catalyst for a direct formic acid fuel cell comprising a noble metal and a metal oxide.

2. The catalyst of claim 1, wherein the noble metal is supported on the metal oxide.

3. The catalyst of claim 1, wherein the noble metal is at least one of palladium and platinum.

4. The catalyst of claim 1, wherein the metal oxide is at least one of TiO₂, CeO₂, ZrO₂, SnO₂, In₂O₅, Sb₂O₅, alloys thereof, and combinations thereof.

5. A direct organic liquid feed fuel cell comprising:
(a) an anode;
(b) a cathode;
(c) a liquid organic fuel comprising formic acid; and
(d) an anode catalyst, comprising a noble metal and a metal oxide.

6. The fuel cell of claim 5 wherein the noble metal is supported on the metal oxide.

7. The fuel cell of claim 5 wherein the noble metal is at least one of palladium and platinum.

8. The fuel cell of claim 5 wherein the metal oxide is at least one of TiO₂, CeO₂, ZrO₂, SnO₂, In₂O₅, Sb₂O₅, alloys thereof, and combinations thereof.

9. A method of reducing catalyst poisoning in a direct organic liquid feed fuel cell comprising preparing a catalyst comprising a noble metal and a metal oxide.

10. The method of claim 9 wherein the noble metal is supported on the metal oxide.

11. The method of claim 9 wherein the noble metal is at least one of palladium and platinum.

12. The method of claim 9 wherein the metal oxide is at least one of TiO₂, CeO₂, ZrO₂, SnO₂, In₂O₅, Sb₂O₅, alloys thereof, and combinations thereof.

13. A method of preparing an anode catalyst for a direct liquid feed fuel cell comprising:
(a) admixing a noble metal and a metal oxide; and
(b) depositing the admixture on an electrically conductive sheet material to form an anode.
